(19) United States
(12) Patent Application Publication
(10) Pub. No.: US 2002/0029213 A1
(43) Pub. Date: Mar. 7, 2002

(54) Method and system for resource allocation

(76) Inventors: Roumen Borissov, Somerville, MA (US); Kyr Gaganidze, Santa Fe, NM (US); Alexander Outkin, Santa Fe, NM (US)

Correspondence Address: PENNIE & EDMONDS LLP, 1667 K STREET NW, SUITE 1000, WASHINGTON, DC, 20006

(21) Appl. No.: 09/785,412

(22) Filed: Feb. 20, 2001

Related U.S. Application Data
(60) Provisional application No. 60/183,149, filed on Feb. 17, 2000.

(51) Int. Cl. G06F 7/00; G06F 17/30

(52) U.S. Cl. 707/7

(57) ABSTRACT

The present invention relates generally to a method and system for allocating resources to needs. More specifically, the present invention presents a system and method that allocates resources to needs by defining a currency, accepting bids for the needs in the currency from the resources and determining an optimal match between the bids and the needs.

### RELATED APPLICATIONS

The present invention claims priority to U.S. provisional application number 60/183,149, filed on Feb. 17, 2000, titled, “A System and Method for Resource Allocation”, the contents of which are herein incorporated by reference.

### FIELD OF THE INVENTION

The present invention relates generally to a method and system for allocating resources to needs. More specifically, the present invention presents a system and method that allocates resources to needs by defining a currency, accepting bids for the needs in the currency from the resources and determining an optimal match between the bids and the needs.

### BACKGROUND

There exists a need for a method and system to improve the process of staffing projects with resources such as employees and consultants. In particular, there exists a need for a method and system having more effective ways for employees and consultants to select the project that they work on in order to maximize both the utilization of their skills and their satisfaction with their work. There exists a further need for a method and system that improves the transparency of the staffing process by giving consultants and employees the incentive to keep their competency profiles up-to-date.

The long-term business drivers for developing these new processes & systems include:

Increase employee retention (reduce turnover, which is currently about 20% per year) by increasing employees' satisfaction with their staffing;

Improve transparency of the staffing system and encourage the employees to keep their competency profiles up-to-date;

Give incentive to all employees to work on a balanced mix of both desirable and undesirable projects;

Optimize the sales and recruitment processes, using feedback from the market-based resource self-allocation system; and

Provide feedback to help employees with their learning and professional development.

### SUMMARY OF THE INVENTION

The present invention comprises a method and system that improves the process of staffing projects with resources such as employees and consultants. The method and system of the present invention comprises more effective ways for employees and consultants to select the project that they work on in order to maximize the utilization of their skills and their work satisfaction. The present invention also improves the transparency of the staffing process by giving consultants and employees the incentive to keep their competency profiles up-to-date. It is an aspect of the present invention to present a system for allocating one or more resources to one or more projects comprising:

one or more needs associated with the one or more projects;

a currency for bidding for said one or more needs;

one or more bids in said currency from said one or more resources for said one or more needs;

a matching component determining at least one optimal one of said one or more bids for matching at least one of said resources to at least one of said needs.

### BRIEF DESCRIPTION OF THE DRAWINGS

FIG. 1 illustrates a process diagram for the project staffing process 100 of the present invention.

FIG. 2 illustrates a process diagram for the bid generation process 200 of the present invention.

FIG. 3 illustrates a process diagram for the profile generation process 300 of the present invention.

FIG. 4 discloses a representative computer system in conjunction with which the embodiments of the present invention may be implemented.

### DETAILED DESCRIPTION OF THE PREFERRED EMBODIMENT

1. Introduction

The present invention comprises a method and system that improves the process of staffing projects with resources such as employees and consultants. The objectives of the present invention include the development of a mechanism for self-allocation of resources to projects through a market-based bidding system. The present invention includes four major components:

1. Currency—The present invention includes a calibration of an appropriate currency as a measure that captures the nature of the tradeoff between current staffing and future opportunity. The present invention also determines the sensitivity of the market mechanism to definition of currency and other aspects of the incentive structure.

2. Market Mechanism—The core of the market system of the present invention includes a matching engine that allows resources to bid on needs for which they are qualified using the established currency. Additional processes and systems track and update available currency balances.

3. Visualization—The preferred embodiment of the present invention allows resources to see all available needs on all projects for which they qualify, and some set of needs for which they do not qualify. Showing resources needs for which they do not qualify help them understand in what areas they need to improve in order to be eligible for more desirable needs or projects.

4. Certification—In the preferred embodiment, in order to ensure the integrity of the bidding and staffing process, employee profiles (records of their current qualifications) are kept up to date, and are certified for accuracy. Processes ensure timely updates and verification of employee profiles. In an alternate embodiment, employee profiles are assumed to be accurate.

The present invention includes the following objectives:

Increase transparency in the staffing allocation process;

Facilitate dissemination of information;

Allow resources to actively participate in their own staffing and career development;

Minimize short term organizational impact;

Demonstrate effectiveness of the method and system of the present invention; and

Build a foundation that can be extended with additional features.

2Functional Requirements

2.1 Processes

This section presents the details of the following processes:

1. An overall project staffing process

2. A bidding process

3. A profile update and verification process

Each process diagram illustrated in the figures is accompanied by a text description of the steps in the process. These processes present some key portions of the present invention.

2.2 Process Diagrams

2.2.1 Project Staffing Process

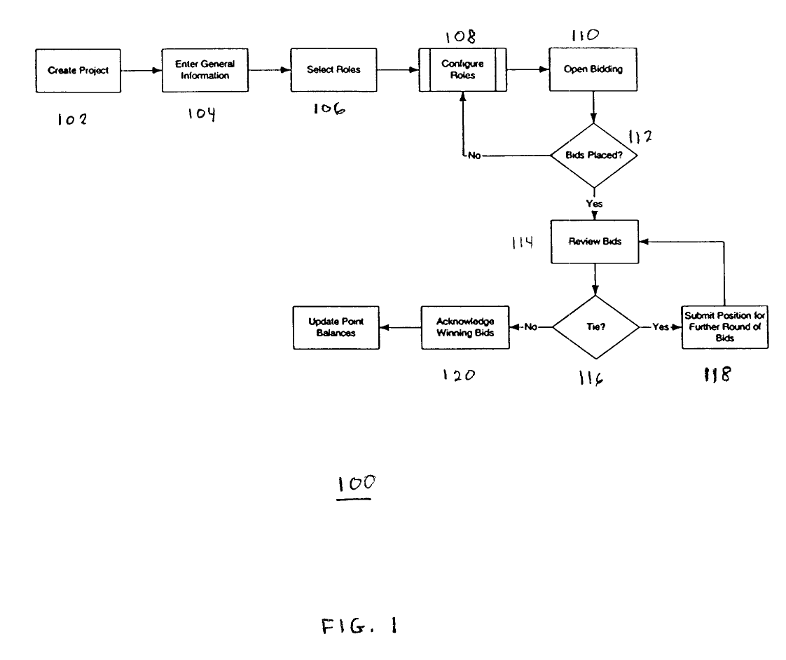

FIG. 1 illustrates a process diagram for the project staffing process 100 of the present invention. The project staffing process begins with the creation of a project in the system (step 102). The project is defined by general project information, including client, description of work, location, expected duration, start and end dates, etc. and by the needs required to complete the work (step 104). Once needs have been defined, each need is preferably configured with the specific set of competencies and proficiencies required, and with the functional level of the desired resource (step 108). Upon completion of need configuration, the needs are opened for bidding (step 110). If no bids are placed, the project manager (in step 108) can reconfigure the needs, if desired (possibly to lower the required proficiency levels, or to redefine the responsibilities of individual needs to make them more applicable to available resources), and reopen bidding (step 110). Once bids have been submitted, any ties can be resolved, and winning resources can be notified (steps 112-118).

2.2.2 Bid Generation Process

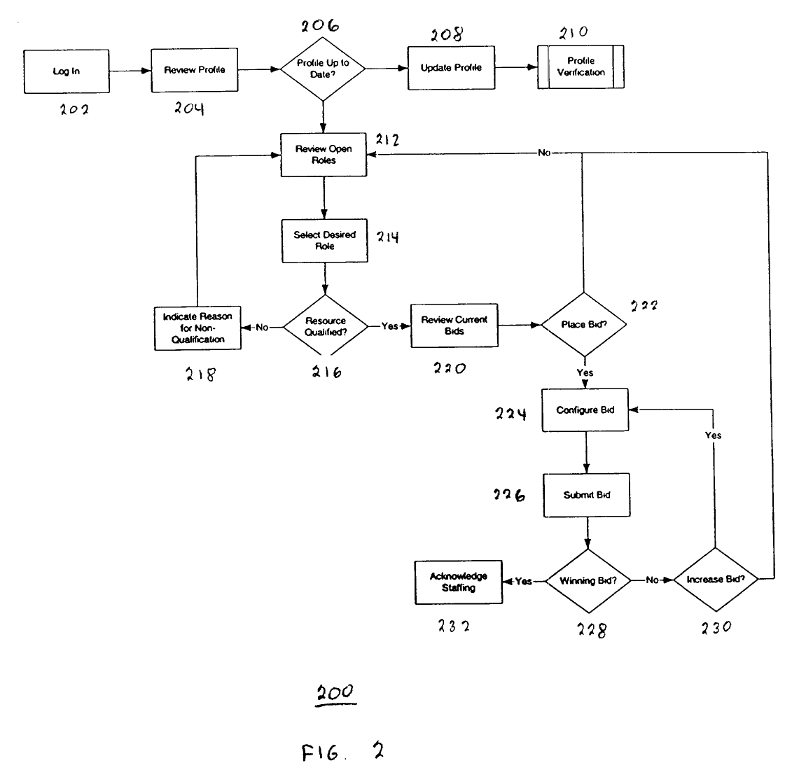

FIG. 2 illustrates a process diagram for the bid generation process 200 of the present invention. Some fixed period of time before a resource rolls off a project, he or she will be able to log into the staffing system (step 202) to begin the process of finding their next project. When they log into the system, they should review their profiles (step 204) and, if necessary, make any changes based on experience from their current projects, or any training received since they last updated their profile (steps 206 and 208). If they update their profiles (step 208), the changes will be validated in the profile verification process (step 210).

Once their profile has been updated and verified, resources such as employees and consultants can review open needs for which they are qualified (step 212). They can check project information and need requirements for all needs for which they are qualified, and some for which they are not (steps 214-220). Once they have identified a need or needs on which they wish to bid, they can place a bid on those needs (steps 222-226). Upon close of bidding on a need, they will be notified if they have won the need (step 228), and their currency balance will be adjusted accordingly (step 232). They will also be able to adjust their bids until the close of bidding (step 230).

One objective of the preferred embodiment of the present invention is to help employees participate in their own career development. Showing them needs for which they are not qualified (along with where the mismatches are), but in which they may be interested is one way of helping them direct their choice of training and selection of future projects. In order to make the system as usable as possible this visibility is preferably balanced against the number of non-qualified-for needs shown to users. The criteria for filtering non-qualified-for needs include: functional level, goodness of fit between resource and need, personal preferences and current development objectives.

2.2.2 Profile Generation Process

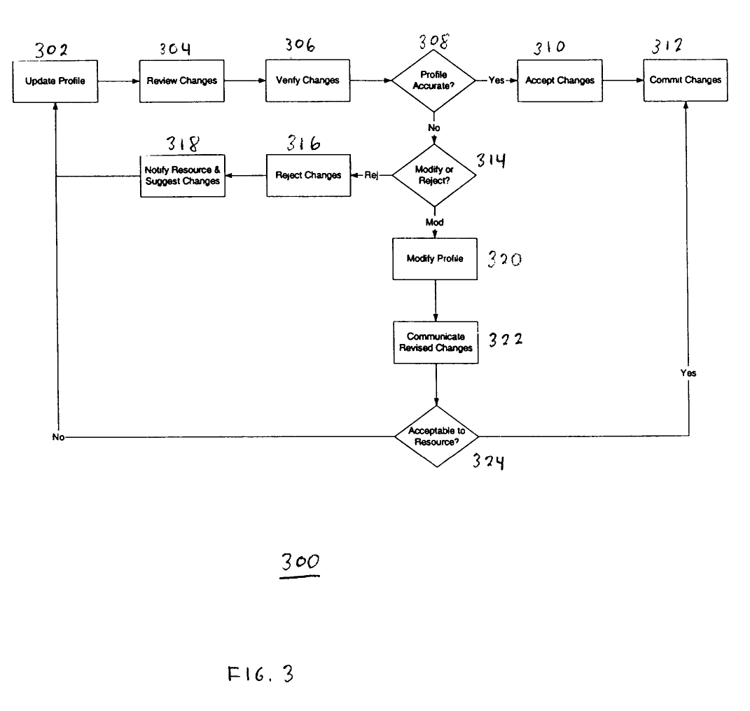

FIG. 3 illustrates a process diagram for the profile generation process 300 of the present invention. When a resource's competencies or proficiency levels change, either through project experience, training, or some other activity, they should update their profile in the staffing system (step 302). Once the resource has made changes, a resource coordinator will review the update to ensure its accuracy (steps 304-306). If the changes are found to be accurate, they are committed to the database, and will be used to determine qualification for needs in any future staffing (steps 308-312). If the changes are found to be inaccurate, they can either be rejected or modified, based on information gathered by the resource coordinator (step 314). If the changes are modified (step 320), the resource should be notified of the update (step 322), after which, if the changes are acceptable to the resource (step 324), they will be committed to the database (step 312). If the original changes or the modifications by the resource coordinator are rejected, the resource can start the process over again (step 302).

The present invention includes a policy, procedure or guidelines regarding turnaround time for profile verification. These guidelines help to ensure that resources can update their profiles and be able to bid on needs based on their updated qualifications in an acceptable amount of time.

In the preferred embodiment of the present invention, resource coordinators are able to play a more active role in the professional development of the resources. Based on discussions with resources or on the stated development objectives of resources, the resource coordinators are able to suggest training courses or project needs that are in line with personal development objectives, or that will help the resource qualify for needs in which they are interested. Critical to this activity is the visibility of needs and qualifications allowed by the preferred embodiment of the present invention.

3 Currency and Market Definition

3.1 Introduction

This section outlines the conceptual and technical basis of the preferred embodiment of the staffing system of the present invention. It is divided into the following topics:

System Components—provides high level definitions of the various interacting parts of the system

Currency Definition—presents the conceptual basis of the currency and the mechanics of assigning value to projects

System Processes—covers eligibility verification and the bidding process

Market Clearing Mechanism—details the process by which the outcome of bidding will be determined

Additional Issues & Objectives—outlines and addresses objectives of and issues with the preferred embodiment of the present invention.

3.2 System Components

3.2.1 Resources

In a preferred embodiment of the present invention, every consultant maintains a profile that tracks their functional level, their set of competencies and their proficiencies in each competency. This profile defines them as a resource to the system. Preferably, the consultant's profile is created when they are hired, and is updated after each project the consultant works on and after any other event or activity that impacts their competencies (e.g. training). The details of the profile update and verification process were described in Section 2—Process Definitions.

3.2.2 Projects

A project is defined in a preferred embodiment of the present invention as the set of needs required to deliver on a client engagement. While the project has attributes of its own (client, location, expected duration, etc), it serves primarily as a container for needs.

3.2.3 Needs

A need is defined in a preferred embodiment of the present invention as the set of competencies and associated proficiencies, and a desired functional level required to perform a particular function on a project.

3.2.4 Points

Points are the basic unit of currency in a preferred embodiment of the staffing market of the present invention. The system records the number of points available to each resource at any given moment. These points can be spent to bid on current projects, or can be earned and saved for use in bidding on future projects.

3.3 Currency Definition

The conceptual basis of a preferred embodiment of the present invention is the tradeoff between satisfaction with current staffing and future opportunity to work on desirable projects. Since time is both a characteristic that is common to all projects and a contributing factor in the perception of the desirability of a project it is used as a simple measure of value for the currency in a preferred embodiment. Time is also understood and valued similarly by all employees, and is an objective measure that can be compared across multiple projects. There are a number of additional features of the currency that are also defined:

Value of a Point: The currency in a preferred embodiment is calibrated to some unit of measure (time). This is preferably accomplished by setting bounds on the range of bids that can be placed on a given project that are related to the common measure and are consistent across all projects.

Convertibility: The value of points in a preferred embodiment is restricted to the staffing system. In an alternate embodiment, the staffing system assigns external value to points (e.g. points might be traded in for training time, relocation, additional vacation, etc.).

Tick Size: The number of points associated with the minimum increment in the perceived value of a need (tick size) has implications for the system's ability to determine price. A preferred embodiment of the present invention sets the right tick size to improve the usability and efficiency of the system.

The preferred embodiment of the present invention defines and calibrates the characteristics of the currency to create an intuitive and usable system.

A preferred embodiment of the present invention defines and allocates points to consultants. In a preferred embodiment, consultants earn points in the following ways:

Upon entry of a consultant into the system (system initiation or new hire), all consultants are given a fixed number of points (equivalent to a signing bonus for new hires).

When working on a billable project or equivalent (e.g. internal investment), consultants earn a fixed number of points every month (equivalent to a salary). Consultants do not earn points when they are not staffed (i.e. on vacation). A reasonable relationship between the signing bonus and monthly salary is determined by the present invention. Resources can also both earn and spend points through the bidding process. When consultants roll off projects and are looking for their next assignment, they are able to review open needs for upcoming projects. Depending on their perception of the attractiveness of each need for which they qualify, resources are able to either bid points they must be paid to fill a need they find unattractive, or bid points they are willing to pay to fill a need that they like.

In the first case, for each open need for which resources qualify, they are able to specify a number of points (up to a maximum for each project based on its duration) that they would have to be paid in order to be willing to work on the project. If no other available resource would be willing to work on the project for fewer points, the consultant is assigned to the project and has points added to their current point balance.

In the second case, the consultants are able to specify the number of points (up to the number of points they have accumulated through past project work) that they would be willing to pay to be assigned to the project. If no other available resource is willing to pay more to work on the project, the consultant is assigned to the project and has points deducted from their current point balance.

With this scheme of a preferred embodiment of the present invention, consultants decides how many of their points they are willing to spend to work on an immediate project, and how many they want to save for bidding on desirable projects that may be available in the future.

3.4 System Processes

3.4.1 Eligibility Verification

The core of the eligibility determination process in a preferred embodiment of the present invention includes a matching engine that takes the definition of an open need (a set of required competencies and associated proficiencies, and a desired functional level), and finds all available resources with proficiencies at or above those required for performing the need. Once this matching is complete, the resources that have been determined to be eligible for the need can place bids on that need. The final determination of which resource is actually allocated to the need is determined by the market mechanism. In the preferred embodiment, competencies and proficiencies will not be factored into the staffing equation beyond determining basic eligibility.

3.4.2 Bidding Process

To restate the bidding process that was described in the currency definition section:

For each open need for which an available consultant qualifies, he or she will be able to specify the number of points he or she is willing to pay (for projects/needs that are perceived by the consultant as desirable) or must be paid (for projects/needs that are perceived by the consultant as undesirable) to work on the project.

If a consultant bids on multiple needs simultaneously, he or she orders the bids by preference. In the event that the consultant has multiple winning bids, he or she will be awarded the need for which the highest preference was expressed. The consultants remaining bids will be canceled and new winning bids will be determined.

In a preferred embodiment, consultants bidding on multiple needs that close on different dates are awarded the winning need that closes the soonest. In this preferred embodiment, their remaining bids will be canceled and new winning bids will be determined.

3.5 Market Clearing Mechanism

In a preferred embodiment, the mechanism by which the market determines winning bids consists of two participants—consultants (bidders) and project managers (sellers). Any consultant can bid on any available need as soon as he or she qualifies (based on estimated availability and competency matching). In a preferred embodiment, Project Managers monitor bidding on open needs for their projects, and intervene if necessary (by changing competency and/or proficiency requirements).

In a preferred embodiment, consultants generally enter the bidding process as they are completing work on their current project, and are able to bid on open needs for projects that begin after their current project's scheduled end date. In a preferred embodiment, auctions close several days before the actual start date of the project to allow finalization of staffing and to give resources time to make any necessary travel arrangements. With these considerations in mind consultants perform the following steps in a preferred embodiment:

Update their competency profile to reflect any experience/proficiency gained over the course of their current project. These updates are validated by a resource coordinator, and consultants should allow time for this process to take place before they begin bidding. Until their updates have been validated, the system uses their old profile.

Log on to the staffing system with their personal User ID and Password information. The system matches their profile against the requirements for all current open needs, and presents consultants with a list of all needs for which they qualify and for which they will be available. This list displays basic information such as opening and closing times for bidding and time remaining until closing for each need.

During the course of bidding, all current bids, together with the associated preferences indicated by each bidder will be displayed to participating consultants in a preferred embodiment of the present invention. From this information, consultants are able to determine how many other resources are competing for each need, and how the market is valuing those needs. Using this information, bidding will proceed as follows in a preferred embodiment:

1. While participating in the auctions, all consultants can place bids on any needs that they are willing to work on. Consultants typically place higher positive bids (indicating their willingness to pay to work on the project) on those projects they find most attractive, and higher negative bids (indicating the amount they would want to be paid to work on the project) on those projects they find less attractive. There is no requirement for a resource to outbid the current highest bid—any bid between the minimum and maximum is allowed. Consultants are also able to revisit their bids and modify them as many times as they wish.

2. When the auction closes, the need is assigned to the consultant placing the highest bid by the close of bidding. Bidding on all needs on a given project close simultaneously, and all projects closing on a given day close at the same time.

3. When a winning bid is declared, the winner will either pay an amount of points equal to the second highest bid and keep the remainder of his/her points for future bidding (in the event of positive bidding), or be awarded an amount of points equal to the next higher bid (in the event of negative bidding). If only one resource participates in an auction, they will either pay zero points (positive bidding) or be awarded the maximum allowable for the need (negative bidding). This type of system, based on economic theory and experimentation, improves overall satisfaction with the outcome of the bidding process.

4. It is possible that one consultant will have winning bids on more than one need. In order to ensure that at most one need is assigned to each consultant, any resource bidding on multiple needs express preferences for the needs on which they bid. These preferences are only relevant if the resource wins multiple needs, in which case he or she is given the need with the highest preference. When this happens, the winner is removed from the auctions of all other needs on which he/she has bid, and winners of those auctions will be recalculated. This procedure iterates until all the needs are staffed.

In a preferred embodiment of the present invention, in order to ensure participation, if a resource has not been staffed through the market after some amount of allowable beach time, he or she may be assigned to an available un-staffed need (could be first available, or could be at the discretion of a resource coordinator). The allowable time may be related to “structural” vacation time at based on maximum possible utilization rate (based on current projects) and time taken to move between projects. The preferred embodiment of the present invention includes appropriate enforcement policies for the staffing system.

3.6 Additional Issues & Objectives

There are a variety of secondary objectives of the system and issues regarding the operation of the market mechanism of a preferred embodiment of the present invention. These include:

Balance of Satisfaction

The present invention achieves an appropriate balance between working on undesirable projects to earn points and working on desirable projects.

Giving High Performers an Incentive to Work on Undesirable Projects

The present invention achieves this objective by awarding bonus points based on annual performance reviews for bids on undesirable projects

Adjustment of Baseline Value

If no resources are willing to bid on a project, the present invention may increase the baseline value of a project on a case-by-case basis. This type of system preserves the ability of the market to set price, while maintaining control over inflation of the currency.

4 Technical Description

4.1 Basic Components

A preferred embodiment of the present invention uses the following components:

Relational Database Management System—RDBMS back end (MSSQL 7.0)

Java Servlet front end (Enhydra JavaIXML application server). The system preferably operates on a Windows NT4.0 box placed within a company which uses it.

4.2 Database Architecture

In a preferred embodiment, the details and specific parameters of the database architecture varies with the processes and rules for the bidding and market clearing. Exemplary tables include the following:

People
id
firstName
lastName
email
password
skills
id
name
description
profiles
id
personld
skillId
skillLevel
Projects
id
name
projectManagerld
startDate
endDate
Needs
id
title
description
projectld
requirements
id
needld
skillId
skillLevel

5 Conclusions

The market-based resource self-allocation system of the present invention is a tool for meeting the New Economy's demand for flexibility and adaptive behavior. This system allows consultants to assume a much greater role in their own staffing process, which should in turn improve their satisfaction with their work. These improvements will better prepare consulting companies to compete in the increasingly competitive and dynamic world of the New Economy through reduced cost due to consultant turnover and greater efficiency in service delivery.

In a preferred embodiment, the present invention further includes a computer simulator to investigate a great variety of scenarios and rules. Simulations provide sufficient data to optimize the configuration of the staffing system of the present invention.

6 Specification of the Staffing Allocation System of the Present Invention

Terminology

Intention to fill a position at a project is preferably broadcasted as an open Need report. Need is preferably characterized by the following:

Role

Competencies/Proficiencies (Proficiency is a skill level for a given Competency)

Location

Needs are preferably specified at an individual consultant level. Therefore, if a project requires a few people at an otherwise identical position, a proper number of identical Needs are entered into the system. In an alternate embodiment, the number of required people is part of a need specification.

Points (Currency) Accumulation

Points are Preferably Accumulated and Spent on a Cash-only Basis

1) When hired, points are paid as a lump sum.

2) When working on a paid project or equivalent of it (i.e. internal investment), a fixed amount is accrued per unit of time and credited to the Resource account.

3) An appropriate number of points is credited/debited to a Resource with a winning bid.

4) No points are accumulated by a resource that is on vacation.

Bidding

In a preferred embodiment, resources can bid positive or negative amounts of points for a project up to the available points balance. Bidding is preferably independent of other resources' bids (i.e. one can bid lower than the current best bid). Additionally, if a Resource participates in a few auctions that will be cleared at the same time, he/she can specify preferences for projects, which will only be used if the resource wins in a few different auctions at the same time.

In a preferred embodiment, there is a pre-set limit for a negative bid noted as M. This means that no one can bid lower than M.

Auctions are preferably conducted for all the open Needs on a project basis. Two situations are possible here:

1) If every Need is different for a given project and therefore, no two people are needed for an identical position, the best bid for a Need wins and pays the second best price.

2) If there are a few identical Needs for a project, all the needs are auctioned simultaneously via a Dutch auction. In a Dutch auction, if N positions need to be filled, the first N best bids win. In this situation, everyone pays the same price, which is the Nth lowest bid.

After the auction is completed and a Resource is successfully assigned to a project, an appropriate amount is credited/debited to a Resource account. Each auction has a beginning and an end date, which are specified by the Project Manager/Client. Bid changes by the Resource are allowed in a preferred embodiment of the present invention.

Information About Bidding for a Particular Need that is Available to a Resource

Other Resources bids

Other Resources preferences

Auction specification (as described below)

Auction Specification

Need

Project Info (PM, location, etc.)

Beginning/End Date

Points Increment (i.e. the amount by which a bid can be updated such as five points)

Time increment (i.e. how often one can update his/her quotes such as every half hour)

Market Clearing

In a preferred embodiment, market clearing is conducted once a day for all the projects with an appropriate End date. Preferences are used if an individual wins more than one project. If necessary, the market clearing process iterates.

In a preferred embodiment, each Resource is eligible to a certain amount of vacation time. However, after this vacation time expires, a Resource can be assigned to a project on an involuntary basis.

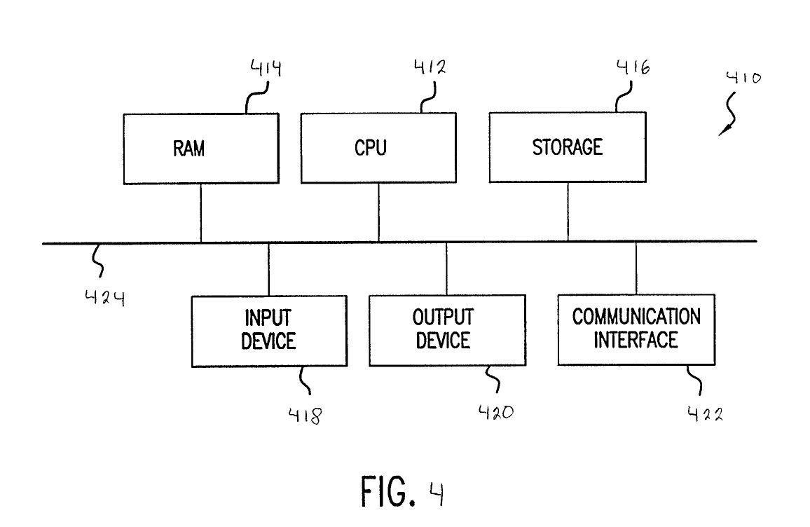

FIG. 4 discloses a representative computer system 410 in conjunction with which the embodiments of the present invention may be implemented. Computer system 410 may be a personal computer, workstation, or a larger system such as a minicomputer. However, one skilled in the art of computer systems will understand that the present invention is not limited to a particular class or model of computer.

As shown in FIG. 4, representative computer system 410 includes a central processing unit (CPU) 412, a memory unit 414, one or more storage devices 416, an input device 418, an output device 420, and communication interface 422. A system bus 424 is provided for communications between these elements. Computer system 410 may additionally function through use of an operating system such as Windows, DOS, or UNIX. However, one skilled in the art of computer systems will understand that the present invention is not limited to a particular configuration or operating system.

Storage devices 416 may illustratively include one or more floppy or hard disk drives, CD-ROMs, DVDs, or tapes. Input device 418 comprises a keyboard, mouse, microphone, or other similar device. Output device 410 is a computer monitor or any other known computer output device. Communication interface 422 may be a modem, a network interface, or other connection to external electronic devices, such as a serial or parallel port

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

What is claimed is:

1. A system for allocating one or more resources to one or more projects comprising:
one or more needs associated with the one or more projects;
a currency for bidding for said one or more needs;
one or more bids in said currency from said one or more resources for said one or more needs;
a matching component determining at least one optimal one of said one or more bids for matching at least one of said resources to at least one of said needs.

2. A system for allocating one or more resources as in claim 1 further comprising:
an input component receiving one or more profiles of said one or more resources.

3. A system for allocating one or more resources as in claim 2 wherein said profile of said one or more resources comprises at least one of the following: one or more competencies, one or more proficiencies, one or more skills, experience, training, qualifications, availability, functional level, personal preferences and development objectives.

4. A system for allocating one or more resources as in claim 2 further comprising:
a verification component verifying the accuracy of said profiles of said one or more resources.

5. A system for allocating one or more resources as in claim 2 further comprising:
a certification component certifying said profiles of said one or more resources.

6. A system for allocating one or more resources as in claim 1 further comprising an input component receiving information for said one or more needs.

7. A system for allocating one or more resources as in claim 6 wherein said information for said one or more needs comprises at least one of the following: one or more required competencies, one or more required proficiencies; and one or more desired functional levels.

8. A system for allocating one or more resources as in claim 1 further comprising:
an allocation component allocating said at least one matched resource to at least one of the projects that is associated with said at least one matched need.

9. A system for allocating one or more resources as in claim 2 further comprising;
a second input component receiving information for said one or more needs.

10. A system for allocating one or more resources as in claim 9 further comprising:
a filter determining at least one of said needs for which at least one of said resources is qualified.

11. A system for allocating one or more resources as in claim 1 further comprising:
an output component displaying at least one of said needs for which at least one of said resources is qualified.

12. A system for allocating one or more resources as in claim 1 further comprising:
an output component displaying at least one of said needs for which at least one of said resources is not qualified.

13. A system for allocating one or more resources as in claim 1 further comprising:
a currency component allocating said currency among said resources.

14. A system for allocating one or more resources as in claim 13 wherein said currency comprises a plurality of points.

15. A system for allocating one or more resources as in claim 14 wherein said currency allocates a fixed number of said points to at least one of the resources when said at least one resource enters the system.

16. A system for allocating one or more resources as in claim 14 wherein said currency components allocate a fixed number of said points to at least one of the resources when said at least one resource performs work for at least one of said needs.

17. A system for allocating one or more resources as in claim 14 wherein the value of at least one of the points is calibrated to time.

18. A system for allocating one or more resources as in claim 14 wherein said currency comprises a tick size.

19. A system for allocating one or more resources as in claim 18 wherein said tick size is a number of said points that is associated with a minimum increment on a perceived value of at least one of said needs.

20. A system for allocating one or more resources as in claim 1 wherein said currency comprises a plurality of points.

21. A system for allocating one or more resources as in claim 20 wherein at least one of said bids is a member of said points that at least one of said resources must be paid to fill at least one of said needs.

22. A system for allocating one or more resources as in claim 21 wherein said at least one bid that is said number of said points that said at least one resources must be paid is negative.

23. A system for allocating one or more resources as in claim 20 wherein at least one of said bids is a number of said points that at least one of said resources is willing to pay to fill at least one of said needs.

24. A system for allocating one or more resources as in claim 23 wherein said at least one bid that is said number of said points that said at least one resource is willing to pay is positive.

25. A system for allocating one or more resources as in claim 22 wherein said number of said points that at least one of said resources is willing to pay is limited by a number of said points that said at least one resource has accumulated.

26. A system for allocating one or more resources as in claim 1 wherein those of said bids originating for at least one of said resources are ordered according to preference of said at least one resource.

27. A system for allocating one or more resources as in claim 1 further comprising:
an output component displaying three of said bids that have been made for at least one of said needs.

28. A system for allocating one or more resources as in claim 1 wherein said at least an optional bid is the highest one of said bids from said resources for said at least one need.

29. A method for allocating one or more resources to one or more projects comprising the steps of:
associating one or more needs with the one or more projects;
defining a currency for bidding for said one or more needs;
receiving one or more bids in said currency from said one or more resources for said one or more needs; and
determining at least one optimal one of said one or more bids for matching at least one of said resources to at least one of said needs.

30. Computer executable software code stored on a computer readable medium, the code for allocating one or more resources to one or more projects, the code comprising:
code to associate one or more needs with the one or more projects;
code to define a currency for bidding for said one or more needs;
code to receive one or more bids in said currency from said one or more resources for said one or more needs; and
code to determine at least one optimal one of said one or more bids for matching at least one of said resources to at least one of said needs.

31. A programmed computer system for allocating one or more resources to one or more projects comprising at least one memory having at least one region storing computer executable program code and at least one processor for executing the program code stored in said memory, wherein the program code includes
code to associate one or more needs with the one or more projects;
code to define a currency for bidding for said one or more needs;
code to receive one or more bids in said currency from said one or more resources for said one or more needs; and
code to determine at least one optimal one of said one or more bids for matching at least one of said resources to at least one of said needs.
